(19) United States
(12) Patent Application Publication
(10) Pub. No.: US 2002/0070577 A1
(43) Pub. Date: Jun. 13, 2002

(54) TAILGATE STEP ASSEMBLY

(76) Inventors: William Bryan Pool III, Pasadena, TX (US); James Louis Kennedy, Pasadena, TX (US)

Correspondence Address: Michael Bruce Jolly, 1018 Preston, 4th Floor, Houston, TX, 77002, US

(21) Appl. No.: 09/733,702

(22) Filed: Dec. 8, 2000

(51) Int. Cl. B60R 3/02

(52) U.S. Cl. 296/62; 280/164.1

(57) ABSTRACT

A tailgate step apparatus including a tailgate with an inner edge and an outer edge, a first channel affixed within the tailgate so as to extend between the inner and outer edges, a second channel affixed within the tailgate so as to extend between the inner and outer edges in generally parallel spaced relationship to the first channel, a frame assembly slidably received within the tailgate between the first and second channels so as to be movable between a first position within the tailgate to a second position extending outwardly of the tailgate, and a step member pivotally connected to the frame so as to have a surface positioned outwardly of the outer edge of the tailgate when the frame assembly is in the second position. The step member is movable so as to assume a horizontal orientation when the frame assembly is in the second position. The frame assembly is retractable along the first and second channels so as to be received interior of the tailgate.

### TECHNICAL FIELD

The present invention relates to land vehicles. More particularly, the present invention relates to truck-type vehicles. The present invention also relates to the tailgates of such vehicles and mechanisms associated with such tailgates so as to facilitate the ingress and egress from the bed of such trucks.

### BACKGROUND ART

It has always been a problem in the ingressing into and the egressing from the cargo beds of relatively large wheel vehicles, such as pickup trucks. Even the small pickups have a cargo bed which is between two and a half and three feet off of the ground. With four-wheel drive versions of such pickup trucks, the height of the pickup trucks from the ground can be in excess of three feet. Standard size pickup trucks average close to three feet in height of the cargo bed. The four-wheel drive versions of the standard sized pickup trucks can have the bed, on occasion, five feet or more in height.

Although these elevated cargo beds are convenient to load, they are very difficult to physically enter into and exit. Often, persons must initially kneel on the tailgate and then crawl into the interior of the truck. Under other circumstances, ladders can be fashioned so as to go over the sides of the vehicle and into the bed of the truck. When leaving the bed of the pickup truck, a person must often jump for a relatively great distance or otherwise slip and slide from the vehicle. Fundamentally, there is simply no easy way to physically enter and exit the cargo bed.

U.S. Pat. No. 4,639,032, issued on Jan. 27, 1987 to E. J. Barbaur, teaches a tailgate step apparatus. This apparatus is a retractable step that can be either retrofitted to a standard pickup truck type tailgate or can be made into the tailgate during the manufacture of the vehicle. This step is of a disappearing type and would not be visible except when extended and folded down into its operative or use position. The step is accomplished through the use of a track positioned within the tailgate and a pivot arrangement whereby the step will hang vertically downwardly from the outer edge of the tailgate. Unfortunately, with this device, it is very difficult for the user to actually see the step when it hangs vertically downwardly from the bottom of the tailgate. Users will often require clear visibility of the apparatus before they will actually utilize such a device. It is often difficult to step to the edge of the tailgate, look downwardly, and then make a determined step so as to leave the bed of the truck.

It is an object of the present invention to provide a step apparatus for the tailgate of a pickup truck.

It is another object of the present invention to provide a step apparatus whereby the steps are arranged in a horizontal orientation.

It is another object of the present invention to provide a step apparatus whereby the steps associated with the apparatus extend outwardly of the outer edge of the tailgate.

It is another object of the present invention to provide a step apparatus whereby the steps are visible by a person standing on the tailgate area.

It is another object of the present invention to provide a step apparatus whereby the step apparatus can be easily folded and unfolded for use and storage.

It is still a further object of the present invention to provide a tailgate stepper apparatus whereby the step apparatus can be folded and stowed within the interior area of the tailgate.

It is still a further object of the present invention to provide a tailgate step apparatus which is easy to use, relatively inexpensive and easy to manufacture.

These and other objects and advantages of the present invention will become apparent from a reading of the attached specification and appended claims.

### SUMMARY OF THE INVENTION

The present invention is a tailgate step apparatus comprising a tailgate having an inner edge and an outer edge, a first channel affixed within the tailgate so as to extend between the inner and outer edges, a second channel affixed within the tailgate so as to extend between the inner and outer edges in generally parallel spaced relationship to the first channel, a frame assembly slidably received within the tailgate between the first and second channels and a step member pivotally connected to the frame so as to have a surface positioned outwardly of the outer edge of the tailgate. The frame assembly is movable between a first position within the tailgate to a second position extending outwardly of the tailgate. The step member has a surface positioned outwardly of the outer edge of the tailgate when the frame assembly is in the second position.

In the present invention, the frame assembly extends at an acute angle with respect to the plane of the tailgate when the frame assembly is in the second position. The step member is pivotally movable between a first position in coplanar relationship with the frame assembly and a second position in a horizontal orientation when the frame assembly is in the second position. The frame assembly is coplanar with the first and second channels when in the first position.

In the present invention, the frame assembly includes a frame member positioned between the first and second channels, a first roller assembly received in the first channel and pivotally connected to the frame member, and a second roller assembly received in the second channel and pivotally connected to the frame member. The frame member includes a rectangular outer frame having a forward end, a rearward end, a first side and a second side. A cross bar is connected to the first side and the second side so as to extend in parallel relationship to the forward and rearward ends. The step member is positioned between the rearward end and the cross bar. The step member is pivotable so as to have a surface residing against the cross bar when in a horizontal orientation. A second step member is pivotally connected to the first and second sides between the cross bar and the forward end. The second step member is movable between a first position in coplanar alignment with the rectangular outer frame and a second position extending outwardly therefrom in a horizontal orientation. The second step member resides against the forward end when in the second position.

The roller assemblies include a roller support member, a first roller rotatably connected to the roller support member, and a second roller rotatably connected to the roller support member on a side opposite to the first roller. Each of the rollers has an axis of rotation extending transverse to a longitudinal axis of the first and second channels.

A top stop is affixed to at least one of the first and second channels adjacent to an end of the channel. A bottom stop is affixed to at least one of the channels inwardly of the top stop such that the frame assembly contacts the top and bottom stops so as to assume the acute angle when in the second position. A retainer is positioned at the end of the first and second channels so as to releasably retain the frame assembly in the first position between the first and second channels and within the tailgate.

### BRIEF DESCRIPTION OF THE DRAWINGS

FIG. 1 is a perspective view of the tailgate step apparatus of the present invention.

FIG. 2 is a cross-sectional side view of the tailgate step apparatus in its deployed position.

FIG. 3 is a partial end view showing the tailgate step apparatus in the deployed position of FIG. 2.

FIG. 4 is a plane view, in partial cross-section, of the tailgate step apparatus in its stowed position.

FIG. 5 is an end view showing the tailgate step apparatus in its stowed position.

FIG. 6 is an end view of an alternative embodiment of the present invention.

### DETAILED DESCRIPTION OF THE INVENTION

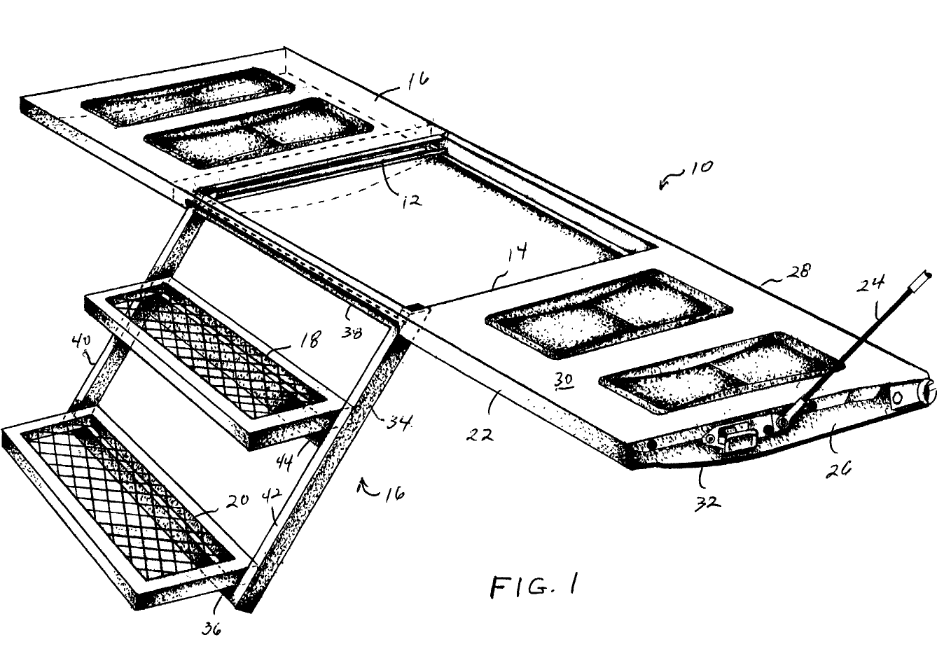

Referring to FIG. 1, there is shown at 10 the tailgate step apparatus in accordance with the teachings of the present invention. The tailgate step apparatus 10 includes a first channel 12 and a second channel 14 mounted within a tailgate 16. A frame assembly 16 is slidably received within the first channel 12 and the second channel 14 so as to be movable between a stowed position within the tailgate 16 to a deployed position (as shown in FIG. 1) extending outwardly of the tailgate 16 at an acute angle to the plane of the tailgate 16. Step members 18 and 20 are pivotally connected to the frame assembly 16 so as to extend outwardly in a horizontal orientation from the outer edge 22 of the tailgate 16 when in the deployed position.

Tailgate 16 is conventionally pivotally connected to the bed of a pickup truck. Strut 24 is connected to a side 26 of the tailgate 16 so as to cause the tailgate 16 to assume its horizontal orientation. When the tailgate 16 is in its horizontal orientation, it is generally coplanar with the bed of the pickup truck so as to allow items on the bed of the pickup truck to be easily moved toward the outer edge 22 of the tailgate 16. The tailgate 16 has an inner edge 28 which is pivotally connected to the end of the bed. The tailgate 16 is movable from its position shown in FIG. 1 to a vertical position enclosing the bed of the pickup truck. The tailgate 16 will have a top surface 30 and a bottom surface 32, each formed of stamped and assembled metal sheets.

The first channel 12 and the second channel 14 are generally C-shaped channels which are affixed within the tailgate 16 between the top surface 30 and the bottom surface 32 of the tailgate 16. The opening to each of the C-shaped channels 12 and 14 faces each other so as to allow for an area in which the frame assembly 16 can appropriately slide. The channel members 12 and 14 will extend generally from the inner edge 28 to the outer edge 22 of the tailgate 16.

The frame assembly 16 includes a generally rectangular outer frame 34 having a forward end 36, a rearward end 38 and sides 40 and 42. A cross bar 44 is connected to the first side 40 and the second side 42 so as to extend in generally parallel relationship to the forward end 36 and the rearward end 38.

As can be seen in FIG. 1, the first step member 18 is positioned between the rearward end 38 and the cross bar 44. The first step member 18 is pivotable so as to have a surface residing against the cross bar 44 when the step member 18 is in a horizontal orientation (such as that shown in FIG. 1). The second step member is also pivotally connected to the first side 40 and the second side 42 of the outer frame 34 between the cross bar 44 and the forward end 36. The second step member 20 is movable between a first position which will be in coplanar alignment with the outer frame 34 to a second position (such as shown in FIG. 1) which extends outwardly therefrom in a generally horizontal orientation. The second step member 20 resides against the forward end 36 when in this second position.

Importantly, as can be seen in FIG. 1, each of the steps 18 and 20 will extend outwardly of the outer edge 22 of the tailgate 16 so that a person standing on the tailgate 16 can easily view the orientation of the steps 18 and 20. Each of the steps 18 and 20 has a relatively large area and extends outwardly in a horizontal orientation. The effective use of the pivotal arrangement and the support caused by the forward end 36 and the cross bar 44 will cause the steps 18 and 20 to be retained in their desired position. Any user standing on the tailgate can easily view the orientation of the respective steps 18 and 20 so as to allow for easy ingress and egress relative to the bed of the truck.

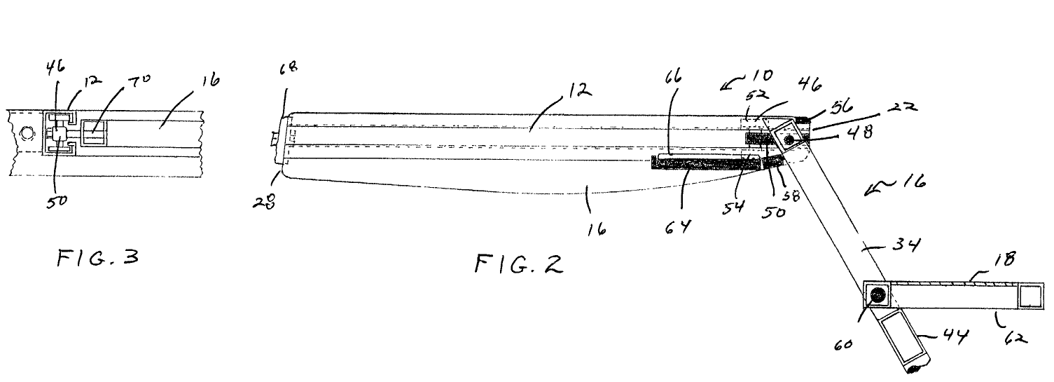

FIG. 2 is a side view of the apparatus 10 of the present invention. For the purposes of illustration, the second step 20 has been omitted. In FIG. 2, it can be seen that the frame assembly 16 is slidably received within the channel 12. So as to facilitate the movement of the outer frame 34 through the channel 12, a first roller assembly 46 is provided. The outer frame 34 is pivotally attached at 48 to the roller support member 50 associated with the roller assembly 46. The roller assembly 46 includes a first roller 52 and a second roller 54 which are rotatably connected relative to the roller support member 50. The rollers 52 and 54 can be of a polymeric or an elastomeric material so as to provide for easy gliding movement of the frame assembly 16 through the channel 12. Each of the rollers 52 and 54 has an axis of rotation which is transverse to the longitudinal axis of the channel 12.

A top stop member 56 is affixed at an end of the channel 12 adjacent to the outer edge 22 of the tailgate 16. A bottom stop member 58 is affixed to the channel member 12 inwardly of the top stop member 56. As can be seen, the outer frame 34 abuts the stops 56 and 58 so as to assume its acute angle orientation relative to the horizontal plane of the tailgate 16.

The outer frame 34 is illustrated as having the cross bar 44 affixed thereto. The first step 18 is pivotally connected at 60 to the outer frame 34. The bottom surface 62 of the first step 18 will abut a surface of the cross bar 44 so as to allow the first step 18 to assumes its horizontal orientation. It can be seen that the first step 18 extends outwardly of the outer edge 22 of the tailgate 16.

FIG. 2 also illustrates the use of the slide mechanism support 64 and the support and slide mechanism 66 so as to allow the frame assembly 16 to be properly stowed and retained within the tailgate 16. A retainer 68 is affixed to the inner edge 28 of the tailgate 16 so as to retain the frame assembly 16 when the frame assembly is moved to its stowed position within the tailgate 16. The retainer 68 can be complementary strips of hook-and-loop material whereby the end of the frame assembly 16 is detachably secured in its stowed position to the tailgate.

FIG. 3 shows a detailed view illustrating the shape of the second channel 14 and how the roller assembly 46 is received within the channel 14. Channel 14 has a generally C-shaped configuration. Axle 70 is connected to the roller support member 50 so as to allow the frame assembly 16 to pivot relative to the roller assembly 16. It can be seen that the rollers 52 and 54 are rotatably mounted relative to the roller support assembly so as to allow the frame assembly 16 to move smoothly and easily through the channel 14. The channel 12 will have a similar configuration as channel 14 and will receive an identical roller assembly.

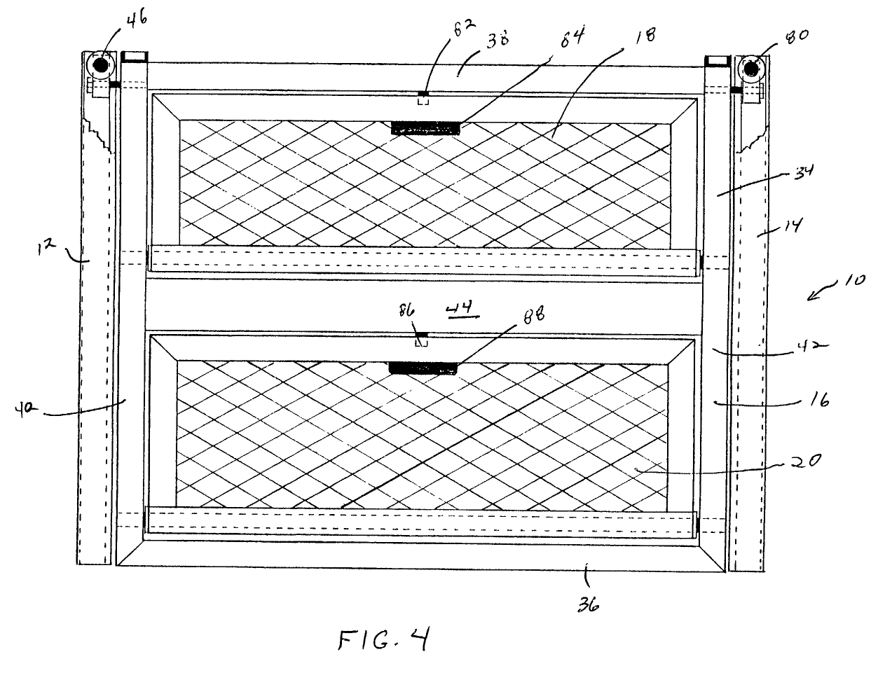

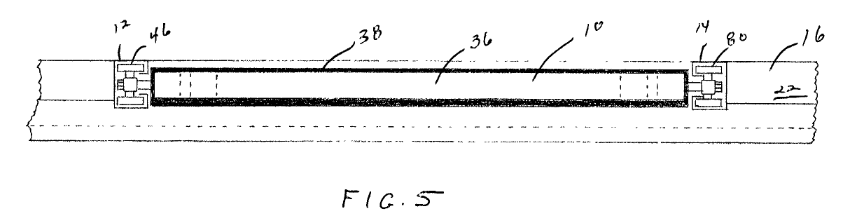

FIG. 4 shows the apparatus 10 in its stowed position within the tailgate 16. Channels 12 and 14 are positioned in spaced parallel relationship with the frame assembly 16 therebetween. The outer frame 34 has sides 40 and 42 residing adjacent to and in parallel relationship with the channels 12 and 14, respectively. The respective roller assemblies 46 and 80 are shown in their stowed position within the respective channels 12 and 14. The first step 18 and the step 20 are pivotally rotated so as to be in coplanar relationship with the outer frame 34. The cross bar 44 will reside between the step members 18 and 20. The step member 18 is pivotally mounted between the rearward end 38 and the cross bar 44. The second step member is pivotally mounted between the cross bar 44 and the forward end 36 of the frame assembly 16. A step stop 82 is affixed to the rearward end 38 and extends toward the cross bar 44. A handle 84 is affixed to the step member 18 so as to allow the step member 18 to be suitably rotated in a convenient manner so that the step member 18 will be in abutment with the step stop 82 for the purposes of moving the assembly 10 to its stowed position within the tailgate 16. Another step stop 86 is affixed to the cross bar 44 and extends toward the forward end 36. The second step member 20 will reside against the step stop 86 when the step member 20 is in its stowed position in coplanar relationship with the outer frame 34. The second step member 20 also includes a handle 88 which allows the user to suitably manipulate the second step member 20. Each of the step members 18 and 20 has its own frame with expanded metal extending in a cross-hatched pattern thereacross. Various other configurations of each of the step members 18 and 20 can be made within the scope of the present invention.

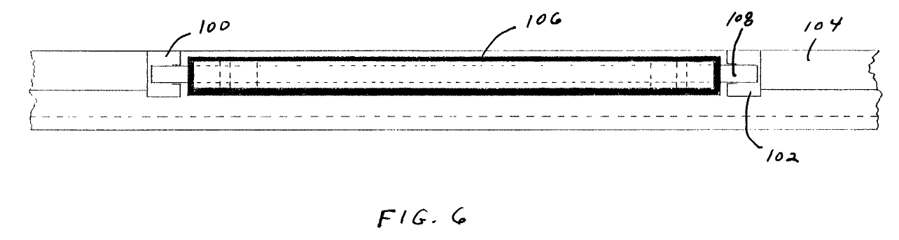

FIG. 5 shows an end view of the tailgate 16 with the step assembly 10 in its stowed position. As can be seen, the forward end 36 of the outer frame 34 is stowed so as to be adjacent to the outer edge 22 of the tailgate 16. Each of the roller assemblies 46 and 80 will reside in their respective channels 12 and 14.

When the step apparatus 10 of the present invention is in its stowed position, conventionally, the user will have the tailgate moved to its vertical position relative to the bed. As such, the step apparatus 10 of the present invention will remain stowed within the tailgate 16 without the need for special retainers or other mechanisms. In order to utilize the present invention, it is only necessary to grasp an end of the step assembly and pull the step members 18 and 20 from their stowed position within the tailgate 16. The step members 18 and 20 can then be pivoted so as to rotate so as to assume their horizontal orientation. After use, each of the step members 18 and 20 can simply be rotated back so as to be in a coplanar relationship with the outer frame 34.

FIG. 6 shows an alternative embodiment of the present invention. In this alternative embodiment, the C-shaped channels 100 and 102 are affixed within the tailgate 104. The frame assembly 106 has a configuration similar to that described herein previously. The frame assembly 106 has a bar 108 affixed thereto. The bar 108 has ends respectively received in the channels 100 and 102. When the frame assembly 106 is moved from its stowed position, the ends of bar 108 will slide through the openings of the respective channels 100 and 102. This embodiment will omit the roller assemblies associated with the previous embodiment.

The foregoing disclosure and description of the invention is illustrative and explanatory thereof. Various changes in the details of the illustrated construction may be made within the scope of the appended claims without departing from the true spirit of the invention. The present invention should only be limited by the following claims and their legal equivalents.

I claim:

1. A tailgate step apparatus comprising:
a first channel;
a second channel in spaced parallel relationship to said first channel;
a frame assembly slidably received within said first and second channels, said frame assembly being pivotable relative to said first and second channels so as to be movable from a first position in generally coplanar relationship with said first and second channels to a second position extending at an acute angle with respect to said first and second channels; and
a first step member being pivotally connected to said frame assembly so as to be extendable in a horizontal orientation when said frame assembly is in said second position.

2. The apparatus of claim 1, said frame assembly comprising:
a frame member positioned between said first and second channels;
a first support received in said first channel and pivotally connected to said frame member; and
a second support received in said second channel and pivotally connected to said frame member.

3. The apparatus of claim 2, said frame member comprising:
an outer frame having a forward end and a rearward end and a first side and a second side; and
a cross bar connected to said first side and said second side so as to extend in parallel relationship to said forward and rearward ends.

4. The apparatus of claim 3, said first step member positioned between said rearward end and said cross bar, said first step pivotable so as to have a surface residing against a cross bar within said horizontal orientation.

5. The apparatus of claim 4, further comprising:
a second step member pivotally connected to said first and second sides between said cross bar and said forward end, said second step member movable between a first position in coplanar alignment with said outer frame and a second position extending outwardly therefrom in a horizontal orientation, said second step member residing against said forward end when in said second position.

6. The apparatus of claim 4, said frame member further comprising:
a step stop affixed to said rearward end and extending toward said cross bar, said first step abutting said step stop when pivoted to a position in coplanar relationship with said square frame.

7. The apparatus of claim 1, further comprising:
a second step member pivotally connected to said frame assembly so as to extend in a horizontal orientation when said frame assembly is in said second position, said step member positioned below said first step member and extending outwardly therefrom.

8. The apparatus of claim 1, said first step member having a handle affixed thereto.

9. The apparatus of claim 2, each of said first and second supports comprising:
a roller support member;
a first roller rotatably connected to said roller support member; and
a second roller rotatably connected to said roller support member on a side opposite said first roller, each of said first and second rollers having an axis of rotation extending transverse to a longitudinal axis of said first and second channels.

10. The apparatus of claim 1, further comprising:
a top stop affixed to at least one of said first and second channels adjacent an end of such channel; and
a bottom stop affixed to at least one of said first and second channels inwardly of said top stop, said frame assembly contacting said top and bottom stops when in said second position.

11. The apparatus of claim 1, further comprising:
a retainer positioned at an end of said first and second channels so as to releasable retain said frame assembly in said first position between said first and second channels.

12. An apparatus for use on a vehicle comprising:
a tailgate having an inner edge and an outer edge;
a first channel affixed within said tailgate so as to extend between said inner and outer edges;
a second channel affixed within said tailgate so as to extend between said inner and outer edges in generally parallel spaced relationship to said first channel;
a frame assembly slidably received within said tailgate between said first and second channels, said frame assembly movable between a first position within said tailgate to a second position extending outwardly of said tailgate; and
a step member pivotally connected to said frame so as to have a surface positioned outwardly of said outer edge of said tailgate when said frame assembly is in said second position.

13. The apparatus of claim 12, said frame assembly extending at an acute angle with respect to a plane of said tailgate when in said second position.

14. The apparatus of claim 12, said step member movable between a first position coplanar with said frame assembly and a second position in a horizontal orientation when said frame assembly is in said second position.

15. The apparatus of claim 12, said frame assembly being coplanar with said first and second channels when in said first position.

16. The apparatus of claim 12, said frame assembly comprising:
a frame member positioned between said first and second channels;
a first roller assembly received in said first channel and pivotally connected to said frame member; and
a second roller assembly received within said channel and pivotally connected to said frame member.

17. The apparatus of claim 12, said frame assembly comprising:
a frame member positioned between said first and second channels; and
a bar affixed to said frame member and having ends extending outwardly therefrom, said ends being respectively slidably received by said first and second channels.

18. The apparatus of claim 17, said frame member comprising:
a rectangular outer frame having a forward end and a rearward end and a first side and a second side; and
a cross bar connected to said first side and said second side so as to extend in parallel relationship to said forward and rearward ends, said step member positioned between said rearward end and said cross bar, said step member pivotable so as to have a surface residing against said cross bar.

19. The apparatus of claim 18 further comprising:
a second step member pivotally connected to said first and second sides between said cross bar and said forward end, said second step member movable between a first position in coplanar alignment with said rectangular outer frame and a second position extending outwardly therefrom in a horizontal orientation, said second step member residing against said forward end when in said second position.

20. The apparatus of claim 12, said tailgate having an inner surface and an outer surface, said first and second channels being affixed between said inner and outer surfaces.
